(19) United States
(12) Patent Application Publication
(10) Pub. No.: US 2010/0278068 A1
(43) Pub. Date: Nov. 4, 2010

(54) Method and System for Filtering IP Traffic in Mobile IP Networks

(75) Inventors: Sébastien Nobert, Quebec (CA); Olivier Mirandette, Quebec (CA); Audry Larocque, Quebec (CA); Louis Brun, Quebec (CA)

Correspondence Address: FAY KAPLUN & MARCIN, LLP, 150 BROADWAY, SUITE 702, NEW YORK, NY, 10038, US

(73) Assignee: NEURALITIC SYSTEMS

(21) Appl. No.: 12/595,890

(22) PCT Filed: Apr. 16, 2008
(86) PCT No.: PCT/CA08/00716

§ 371 Date: Mar. 2, 2010

Related U.S. Application Data
(60) Provisional application No. 60/907,741, filed on Apr. 16, 2007.

(51) Int. Cl. H04L 12/26

(52) U.S. Cl. 370/253

(57) ABSTRACT

A method for extracting data information from data traffic flowing through a mobile IP network, in view of providing a substantially real-time view of the mobile IP network comprises receiving a copy of the data traffic and extracting sequentially, in relation to a layered-structure of the data traffic, information contained in the received copy of the data traffic. A system to carry out such method comprises a receiver of a copy of the data traffic and an extractor for sequentially extracting, in relation to a layered-structure of the data traffic, information contained in the received copy of the data traffic.

### FIELD

The present invention generally relates to mobile IP networks. More specifically, the present invention is concerned with a method and system for filtering mobile IP traffic in mobile IP networks.

### BACKGROUND

The number of wireless and mobile devices for data and voice transmission has been increasing rapidly and exponentially for the last decade. Indeed, mobility is “the way to go” now, such that mobile data communication is becoming the emerging, if not the imposing technology, for supporting voice and video. This technology is widely used in third generation (3G) cellular networks and wireless Local Area Network (LAN). In order to support mobility functions, networks using mobile IP (Internet Protocol) have been developed.

For example, in standard IP networks, routing is based on IP addresses, which are stationary addresses. Each element in the network keeps its assigned IP address during an entire IP communication session. However, with a mobile device, when this mobile device changes from a first cell to a second cell, the original routing IP address assigned to the mobile device, from the first cell, cannot be used or kept in the second cell. However, when using IP on mobile networks, the mobile device is able to keep its originally assigned IP address while traveling from the first cell to the second cell, which ensures the mobile device a continuous communication without sessions or connections being dropped.

With the attraction of mobility functionalities, there is a constantly increasing number of mobile users, which causes a high demand for larger, more complex and robust mobile IP networks, for supporting a larger amount of traffic flowing therethrough. However, with more complex mobile IP networks comes an urgent need for the network operators to get a real understanding and real-time view of the dynamics of the mobile IP network and of the amount of traffic flowing therethrough, in order to manage appropriately both the traffic and the mobile IP network.

In current mobile IP networks, complex servers and database infrastructures are deployed and used to gather and collect information about the mobile IP networks. More specifically, a large and constantly growing number of applications and services need to be implemented in the mobile IP networks in order to access and retrieve the desired information. By so doing, large software projects are generated. However, they are often jeopardized by the implementation of a plurality of interfaces and an incontrollable growth of data storage, which decrease their efficiency.

Furthermore, in current mobile IP networks, the network operators have only a past view of their traffic, since the collected information is based on static information from the past.

Therefore, there is a need of overcoming the above discussed problems concerning large mobile IP network management. Accordingly, a method and system for real-time filtering and orchestrating mobile IP traffic in mobile IP networks are sought.

### OBJECTS

An object of the present invention is therefore to provide a method and system for filtering IP traffic in mobile IP networks, in particular but not exclusively for business intelligence purposes.

### SUMMARY

More specifically, in accordance with the present invention, there is provided a method for extracting data information from data traffic flowing through a mobile IP network, in view of providing a substantially real-time view of the mobile IP network, the method comprising: receiving a copy of the data traffic; and extracting sequentially, in relation to a layered-structure of the data traffic, information contained in the received copy of the data traffic.

The present invention also relates to a system for extracting data information from data traffic flowing through a mobile IP network, in view of providing a substantially real-time view of the mobile IP network, the system comprising: means for receiving a copy of the data traffic; and means for extracting sequentially, in relation to a layered-structure of the data traffic, information contained in the received copy of the data traffic.

The present invention further relates to a system for extracting data information from data traffic flowing through a mobile IP network, in view of providing a substantially real-time view of the mobile IP network, the system comprising: a receiver of a copy of the data traffic; and an extractor for sequentially extracting, in relation to a layered-structure of the data traffic, information contained in the received copy of the data traffic.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of a mobile IP network according to a non-restrictive illustrative embodiment of the present invention;

FIG. 2 illustrates a block diagram of a filtering and orchestrating server according to a non-restrictive illustrative embodiment of the present invention;

FIG. 3 illustrates a flow chart of a method for extracting and orchestrating IP traffic information on mobile networks according to a non-restrictive illustrative embodiment of the present invention;

FIG. 4 illustrates an example of database tables used in the filtering and orchestrating server of FIG. 2; and

FIG. 5 illustrates examples of information extracted by the filtering and orchestrating server of FIG. 2.

### DETAILED DESCRIPTION

Generally stated, a non-restrictive illustrative embodiment of the present invention is a method and system to easily extract and gather the information that enables the mobile IP network operators to get a real-time and appropriate understanding of the IP traffic on mobile networks. More specifically, a method and system, according to the non-restrictive illustrative embodiment of the present invention, enables to extract core IP traffic on mobile networks in a fully transparent way, outside the mobile IP network critical path, therefore adding no latency to the core IP traffic on mobile networks. Furthermore, such method and system are scalable in terms of their capacity to process traffic up to high volumes. Indeed, such method and system are scalable according to the size of the mobile IP network and the amount of traffic flowing therethrough.

Also, a method and system according to the non-restrictive illustrative embodiment of the present invention provides to the mobile IP network operators a quasi-real-time view, with a certain delay, of the IP traffic on mobile networks as it occurs and flows through the mobile IP network. The information from the quasi-real-time view is not based on past values or static information as in conventional methods and systems of managing networks.

Furthermore, this information can be used for business purposes, not only for managing the networks. For example, a method and system according to the non-restrictive illustrative embodiment of the present invention enables the mobile operator to monitor mobile data service adoption correlating it with devices, location or network access methods, match its service offering with the right or good devices, etc. Mobile data traffic patterns are rapidly identified to prevent abusive usage and detect abnormal situations.

It should be noted that throughout the description hereinbelow, the mention of different layers refers, as a non-limitative example, to the different layers as defined by the Open Systems Interconnections (OSI) model. The OSI model includes seven layers of networking protocols. The seven layers are as follows:
layer 7: application layer;
layer 6: presentation layer;
layer 5: session layer;
layer 4: transport layer;
layer 3: network layer;
layer 2: data link layer; and
layer 1: physical layer.

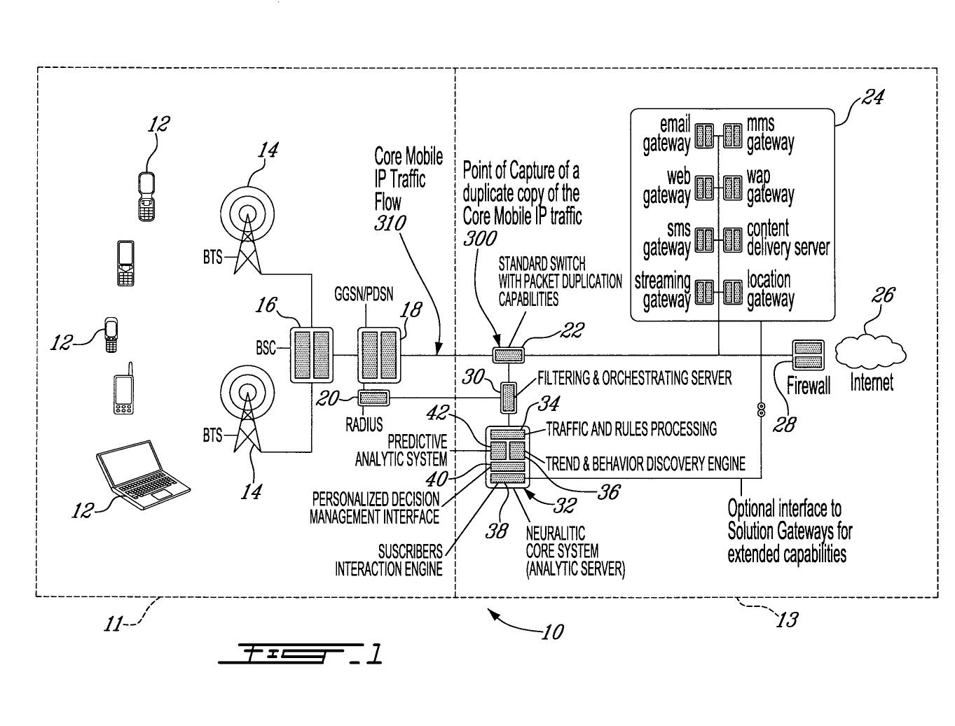

Turning to FIG. 1, an infrastructure of a mobile IP network 10 will be described.

The mobile IP network 10 includes a mobile network 11 interconnected with an IP network 13 through a connection gateway 18. Mobile devices 12, such as cellphones, Personal Digital Assistant (PDA), laptops, etc., having capabilities of roaming and mobility and being connected to the mobile network 11, are provided.

The mobile devices 12 generally use wireless connections such as radio frequencies to access the mobile network 11. Information sent over the air from the mobile devices 12 are received by antennas or transceivers, which are housed in Base Transceiver Stations (BTS) 14. The BTS 14 are connected and controlled by a Base Station Control (BSC) 16. One or more BTS 14 may be used for handling the radio-link protocols with the mobile devices 12. However, in a large urban area, for example, there will be a large number of BTS 14 deployed to take care of a greater number of mobile devices 12. The plurality of BTS 14 is connected to the BSC 16, which manages the radio resources for the plurality of BTS 14. For instance, the BSC 16 handles radio-channel setup, frequency hopping, and generally manages the traffic coming from the mobile devices 12 over the mobile network 11.

The BSC 16 is further connected to the connection gateway 18, which may be a General Packet Radio Service Gateway (GPRS) Support Node (GGSN) or Packet Data Serving Node (PDSN). Therefore, the BSC 16 constitutes a connection between the mobile devices 12 and the GGSN/PDSN 18 in the mobile network 11.

It should be noted that the mobile network 11 can be viewed as a core network and the IP network 13 as a service network.

Also, the connection gateway 18 acts as a concentrator of traffic flowing through the mobile network 11 or the IP network 13, enabling thus to limit the number of required nodes deployed in the mobile IP network 10 in order to obtain a global view of the traffic.

When using industry standards such as Universal Mobile Telecommunications System (UMTS), the connection gateway 18 is the GPRS Support Node (GGSN). The GGSN 18 is a gateway which acts as an interface between the UMTS cellular network, such as the mobile network 11, using the UMTS standard and an external packet data network, such as the IP network 13.

Basically, the GGSN 18 converts the UMTS packets coming from the mobile network 11 into an appropriate packet data protocol (PDP) format, such as IP. Then, the GGSN 18 sends them out on the corresponding packet data network such as the IP network 13. In the other direction, incoming IP data packets, from the IP network 13, are converted into UMTS packets by the GGSN 18 in destination to the mobile devices 12 over the mobile network 11.

When using the Code Division Multiple Access (CDMA) technology, the connection gateway 18 is a PDSN, which is very similar to the GGSN, in terms of functionalities, and therefore acts as a bidirectional interface between the mobile network 11, such as a CDMA network in this case, and the IP network 13.

Furthermore, the connection gateway 18 can be connected to a server 20 using the Remote Authentication Dial In User Service (RADIUS) protocol for example. The RADIUS protocol accesses the mobile IP network 10 to fetch IP addresses. More specifically, the RADIUS protocol may obtain the mapping between a Mobile Subscriber International ISDN Number (MSISDN), which basically corresponds to a standard phone number used to identify a particular mobile user, and its corresponding IP address that has been dynamically allocated to the mobile user for a given IP session. For example, this information may be retrieved by listening to a specific port on the server 20.

Finally, the connection gateway 18 is connected to a standard switch 22 supporting port mirroring for example, which can duplicate the data packets of the core IP traffic on mobile networks and forwards a first copy of the data packets to a service server 24 and forwards a second copy of the data packets to the filtering and orchestrating server 30.

It should be noted that the flow of data packets from the connection gateway 18 to the switch 22 constitutes the core IP traffic on mobile networks flow 310, as illustrated in FIG. 1. More specifically, the core IP traffic can include the traffic flowing between the BSC 16 to the connection gateway 18 or the traffic flowing between internet 26 or a firewall 28 and the connection gateway 18.

The duplicated traffic coming from the switch 22 is processed in the service server 24, according to its nature and associated service, through a corresponding gateway. Then, the processed traffic is sent to the internet 26 through the firewall 28, as illustrated in FIG. 1. The service server 24 includes a plurality of gateways for enabling extended capabilities and enhanced services offered by the mobile IP network 10. For example, the service server 24 may include:
an email gateway for receiving and sending emails;
a web gateway for accessing web pages;
a short messaging service (SMS) gateway for receiving and sending text messages;
a streaming gateway for accessing streaming applications;
a multimedia messaging service (MMS) gateway for receiving and sending multimedia messages such as pictures and videos;
a wireless application protocol (WAP) gateway for accessing Internet;
a content delivery server for copying web pages into geographically distributed servers and for dynamically identifying web pages requested by users; and
a location gateway for providing services that are network and device independent.

It should be pointed out that the strategic location of the switch 22, interposed between the connection gateway 18, which acts as a traffic concentrator, and the rest of the mobile IP network 10, receives mostly all the traffic flowing through the mobile IP network 10 in the filtering and orchestrating server 30.

Also, it is to be noted that since the filtering and orchestrating server 30 is connected to the switch 22, there is no introduction of a point of failure within the mobile IP network 10. Indeed, since the filtering and orchestrating server 30 is located outside of the main path of data packet delivery over the mobile IP network 10, it does not constitute a centralized point of failure in the mobile IP network 10. Furthermore, the filtering and orchestrating server 30 does not introduce additional delay nor generate additional traffic in the mobile IP network 10. This is due to the fact that the filtering and orchestrating server 30 uses a copy of the data packets provided by the switch 22.

Furthermore, the filtering and orchestrating server 30 can also be connected to the server 20, so that its information is available through RADIUS.

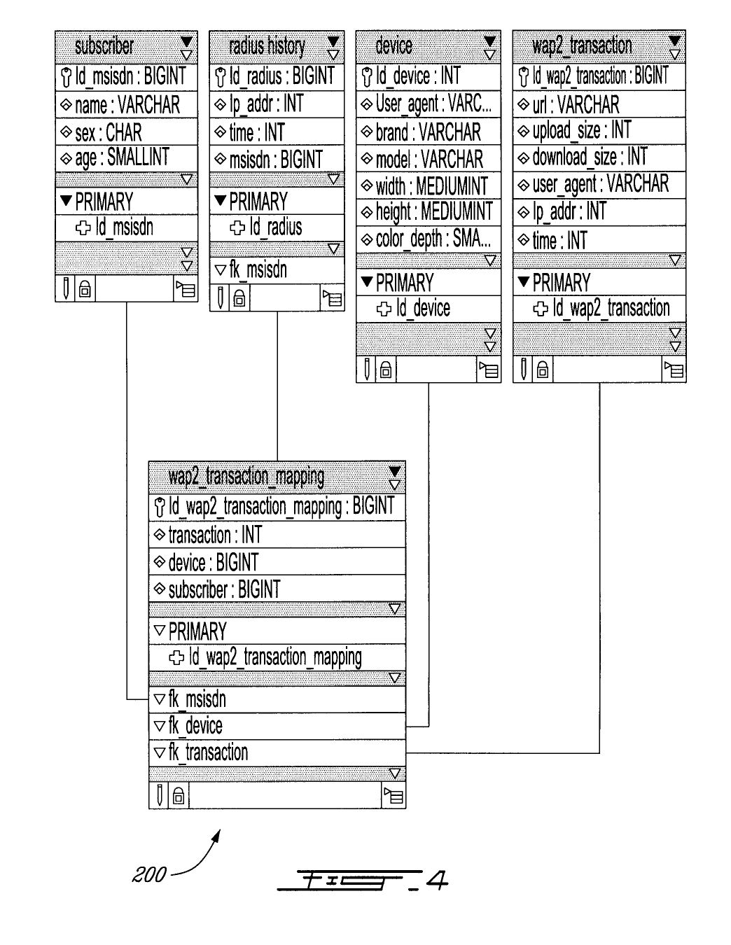

Generally stated, the filtering and orchestrating server 30 is responsible of receiving and extracting the core IP traffic on mobile networks in the mobile IP network 10. More specifically, the filtering and orchestrating server 30 filters or extracts the data packets of the core IP traffic on mobile networks, reconstructs them and then analyzes them in order to store the useful information in a database 200, as shown in FIG. 4, which will be described hereinbelow.

In addition, the architectural design of the filtering and orchestrating server 30 is done in such a way as to support scalability and high availability. For example, high scalability is achieved by using a plurality of small processes so as to take advantage of a plurality of Central Processing Units (CPU). Since the traffic can be split by using load balancing techniques, for example, available on common switches, it is also possible to scale the traffic by using a plurality of servers. High availability is achieved by using shared memory. If a process crashes, the shared memory will still be available for the other processes. The shared memory also enables streaming of data packets, meaning that extraction of the information contained in the data packets is performed while the data packets are being received; there is no need to wait until all the data packets of an IP mobile session have been received. Furthermore, the shared memory can provide for a stateless processing of each single data packet by allowing any instance of a specific extraction process to handle the data packet, for example. By so doing, better availability and scalability are achieved.

However, it should be noted that scalability and availability of the filtering and orchestrating server 30 can be achieved through different ways, other than the plurality of processes and the shared memory respectively.

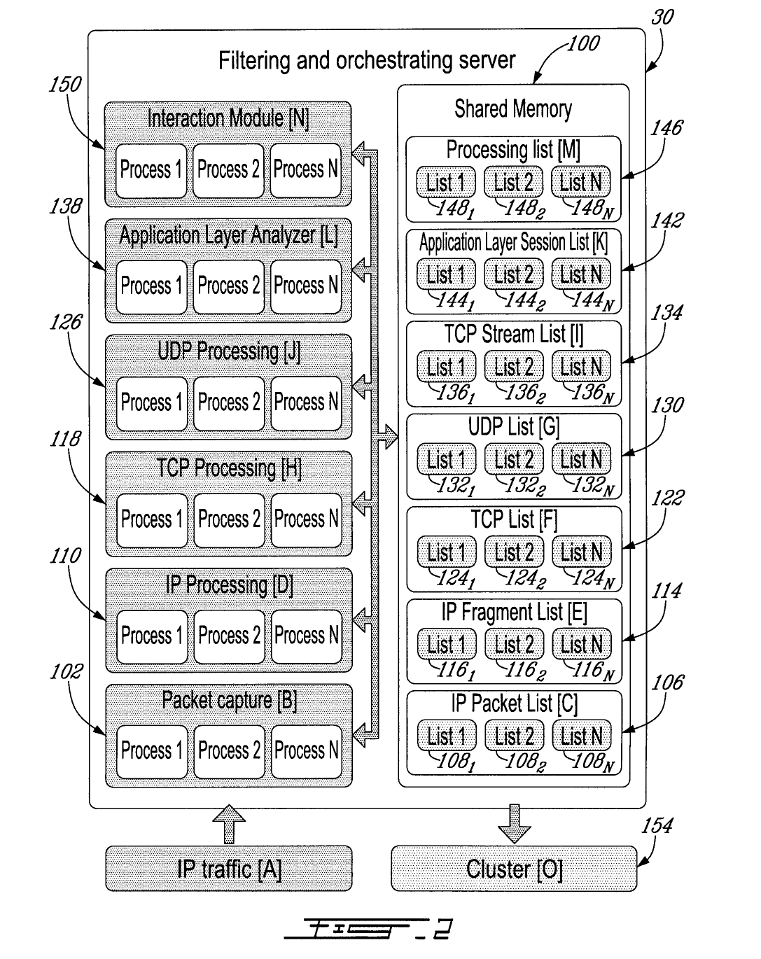

More specifically, as non-restrictive examples illustrated in FIG. 2, the filtering and orchestrating server 30 comprises a shared memory 100, including a plurality of storing elements (106, 114, 122, 130, 134, 142 and 146) in the form of lists, and a plurality of extracting modules (102, 110, 118, 126, 138 and 150), extracting the core IP traffic on mobile networks. Furthermore, as will be described hereinbelow, each extracting module can include a plurality of processes for achieving scalability. Each storing element can include a plurality of lists. The plurality of processes works in conjunction with the plurality of lists.

As illustrated in FIG. 2, a first extracting module consists of a packet capture module 102, which acts as a receiver of the duplicated data packets. Also, the packet capture module 102 captures duplicated data packets from the IP traffic on mobile networks flowing through the mobile IP network 10, on an Ethernet link for example. More specifically, the capture module 102 includes a plurality of processes 104₁ to 104_{N} performing the capture of the duplicated data packets. Once the duplicated data packets are captured, they are read through the plurality of processes 104₁ to 104_{N} so as to extract layer 3 information, i.e. information regarding the network layer, by filtering. The packet capture module 102 may therefore be viewed as a network layer extractor module. The plurality of processes 104₁ to 104_{N} work in parallel with one another and use a packet list 106, located in the shared memory 100, for example. The packet list 106, which can also include a plurality of lists 108₁ to 108_{N}, stores the captured data packets.

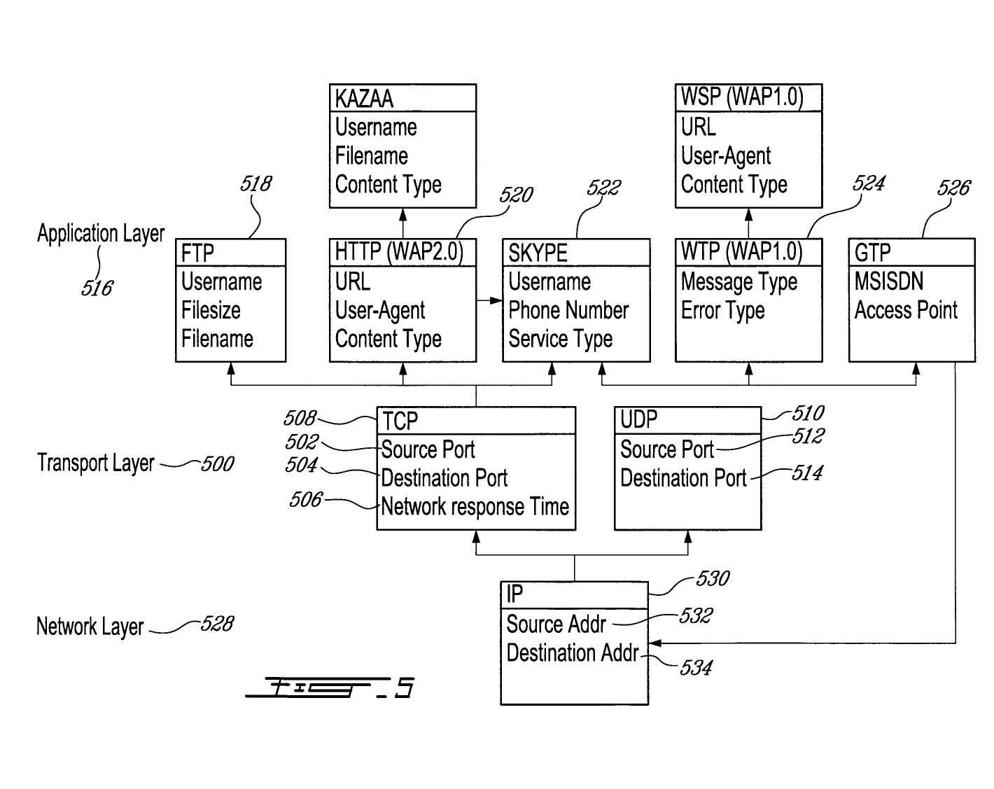

A second extracting module is an IP processing module 110, which includes a plurality of processes 112₁ to 112_{N} for extracting, by filtering, layer 4 information, i.e. transport layer information, of the captured data packets, stored in the packet list 106. The IP processing module 110 may therefore be viewed as a transport layer extractor module. Turning to FIG. 5, non-limitative examples of extracted information of layer 4, corresponding to the transport layer 500, are provided. Such examples are: source port 502, destination port 504 and network response time 506 in the case where the Transmission Control Protocol (TCP) 508 is used as the transport protocol. In the case where the User Datagram Protocol (UDP) 510 is used as the transport protocol, examples of extracted information of layer 4 include source port 512 and destination port 514.

However, if the captured data packets have been first fragmented, the plurality of processes 112₁ to 112_{N} will use data packets previously stored in an IP fragment list 114 from the shared memory 100 for example. The IP fragment list 114 can also include a plurality of lists 116₁ to 116_{N}.

The extracted layer 4 information of the captured data packets, by the plurality of processes 112₁ to 112_{N}, is then stored in a TCP list 122, if TCP is used as the data packet transmission protocol or in a UDP list 130, if instead UDP is used for the data packet transmission protocol. Both the TCP list 122 and the UDP list 130 are provided by the shared memory 100.

A third extracting module is a TCP processing module 118 used to order the captured data packets and to identify the proper upper layer to which the captured data packets will be directed. To do so, a plurality of processes 120₁ to 120_{N} are provided. The plurality of processes 120₁ to 120_{N} reads the data packets from the TCP list 122, which includes a plurality of lists 124₁ to 124_{N}.

Furthermore, a TCP stream list 134 is provided by the shared memory 100 to contain data packets, which are out of order. This TCP stream list 134 is used by the TCP processing module 118 to re-assemble the TCP stream from the data packets in order to obtain an ordered TCP stream. The TCP stream list 134 also includes a plurality of lists 136₁ to 136_{N}.

A fourth extracting module consists of a UDP processing module 126 used to filter the captured data packets and identifying the proper upper layer to which the captured data packets will be directed. To do so, a plurality of processes 128₁ to 128_{N} are provided. These processes read the data packets from the UDP list 130 as input information. Furthermore, the UDP list 130, provided by the shared memory 100, can include a plurality of lists 132₁ to 132_{N}.

The ordered stream of data packets provided by the TCP processing module 118 or the filtered data packets provided by the UDP processing module 126 are stored in an application layer list 142, provided by the shared memory 100. The application layer list 142 can be provided with a plurality of lists 144₁ to 144_{N}.

A fifth extracting module is an application layer analyzer 138, which includes a plurality of processes 140₁ to 140_{N}, for extracting upper layer payload information of the data packets, such as the application layer 7, by filtering. The application layer analyzer 138 may therefore be viewed as an application layer extractor module. This extracted information is subsequently sent to the analytic server 32 of FIG. 1 for further and deeper processing, according to the needs and requirements of the network operators.

More specifically, the processes 140₁ to 140_{N} read the data packets from the application layer list 142, provided by the shared memory 100, and extracts the desired information. For example, as illustrated in FIG. 5, the extracted information of the application layer 516 includes protocols, such as FTP (File Transfer Protocol) 518, HTTP (WAP2.0) 520, SKYPE 522, Wireless Transaction Protocol (WTP-WAP1.0) 524 and GPRS Tunneling Protocol (GTP) 526. Then, the plurality of processes 140₁ to 140_{N} writes the extracted information in a processing list 146, provided by the shared memory 100. The processing list 146 can include a plurality of lists 148₁ to 148_{N}. The information contained in the processing list 146 can be later put into a storing element such as the database 200 shown in FIG. 4, through an interaction module 150, for example. More specifically, the processing list 146 can contain a plurality of SDRs (Session Data Records), which provides useful information related to an IP communication session of a subscriber. By accumulating SDRs, the processing list 146 can limit the number of transactions between the filtering and orchestrating server 30 and a cluster 154, for example.

A sixth extracting module is the interaction module 150, such as an interaction module using Structured Query Language (SQL) for example, which also includes a plurality of processes 152₁ to 152_{N}. The interaction module 150 is responsible for controlling the number of connections between the filtering and orchestrating server 30 and the cluster 154. The plurality of processes 152₁ to 152_{N} is in charge of performing insertion of data in the database 200 using the processing list 146. To do so, command statements can be generated for example, which command the information stored in the processing list 146 to be moved to the database 200.

Of course, other kinds of databases and interacting technologies or standards can be used for storing and moving the processed information.

Furthermore, the cluster 154, which can be a SQL cluster for example, can include a staging database, such as the database 200, for keeping temporarily the real-time data from the processing list 146. Those data can be moved to a further system for a subsequent usage. The analytic server 32, which will be described hereinbelow, can request the information contained in the staging database to be moved to itself. Also, the staging database can be designed so as to support data insertion coming from the filtering and orchestrating server 30 during a real-time network extracting processing at peak hours.

The filtering and orchestrating server 30 is flexible so that additional modules may be added for reading, processing and extracting new protocols of the data packets. Also, the filtering and orchestrating server 30 is so designed as to read, process and extract information of each data packet according to the nature and layer order of the encapsulation of the data packet, which can correspond to the layered-structure of the data packet.

It should be noted that additional extractors can be implemented in the filtering and orchestrating server 30 so as to extract additional information regarding the mobile IP network 10, the mobile devices 12 or additional information about the subscribers, for specific applications. For example, communication session information of a mobile device, functional parameter information of a mobile device, geographical location information about the mobile device, transaction history information of the mobile device during the communication session, session data records and layered-structured information of the data packet, are examples of available additional information available.

Finally, the filtering and orchestrating server 30 is further connected, for example, to the analytic server 32. As a non-restrictive illustrative example of application of the non-limitative embodiment according to the present invention, the information retrieved by the filtering and orchestrating server 30 is sent to the analytic server 32 for further processing and analysis. For example, the analytic server 32 can gather, observe and plot trends and behavior of the filtered traffic in the mobile IP network 10, based on the information extracted by the filtering and orchestrating server 30, during different periods of time and in different geographical regions.

The analytic server 32 can also offer an optional interface to the service server 24, to allow interactions and communications between the subscribers and the different service gateways and corresponding applications of the service server 24.

Furthermore, the analytic server 32 can provide a personalized management interface which can be, for example, a home page where data and services are put together to provide the network operators with access to different components of the analytic server 32, with a simple configurable interface. In addition, a personalized home portal can be provided for each subscriber or network operator to create a personalized profile about the data that he/she needs in order to analyze, track and monitor the mobile IP network 10 using those data.

Also, other functionalities are possible and can be implemented in the analytic server 32.

In addition, storage and archiving are provided for the extracted data coming from the filtering and orchestrating server 30. Storage is also available for additional information, for example coming from supplementary sources for further enhancing the analysis of the filtered data in the analytic server 32.

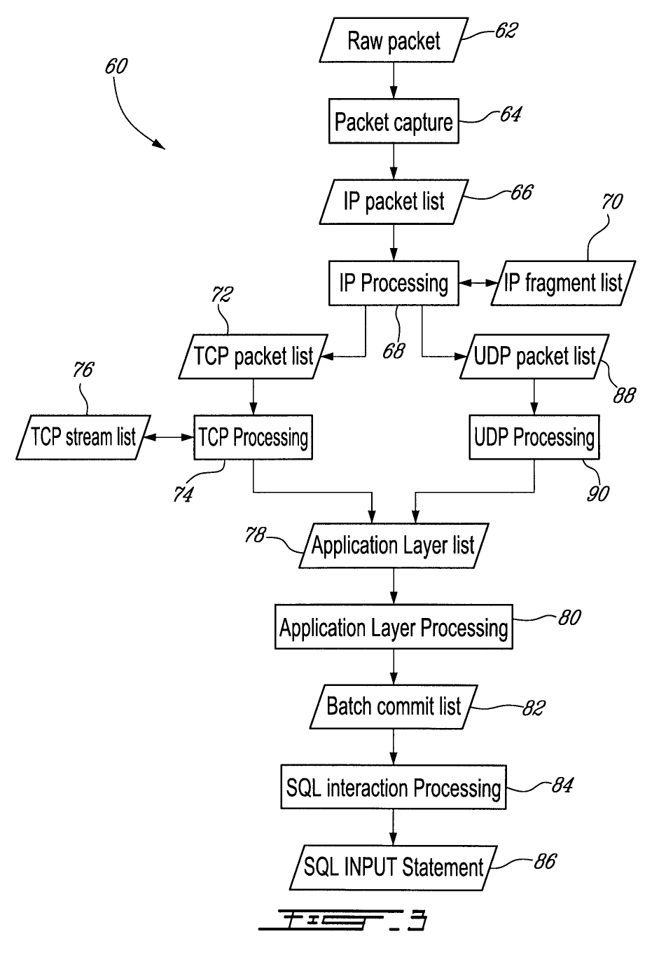

Turning now to FIG. 3, a method 60 of extracting and orchestrating, which may be implemented by the filtering and orchestrating server 30 of FIG. 2, will be described.

It should be noted that a plurality of a same operation can be performed at the same time, since a plurality of processes are run in parallel for performing the operation. However, only one operation is shown in FIG. 3, for clarity purposes.

The method 60 for extracting and orchestrating IP data packets on mobile networks starts at operation 62, where the switch 22 duplicates data packets of the mobile IP network 10 traffic, received from the connection gateway 18 at the point of capture 300, as illustrated in FIG. 1. The duplicated data packets are provided as input to operation 64.

In operation 64, the duplicated data packets are provided as input to the packet capture module 102, shown in FIG. 2. The packet capture module 102 receives the duplicated data packets and then uses the plurality of processes 104₁ to 104_{N} to read the duplicated data packets in order to extract layer 3 information thereof.

For example, as illustrated in FIG. 5, the extracted information of layer 3, corresponding to the network layer 528, includes IP information 530, such as Source Address 532 and Destination Address 534.

More specifically, the plurality of processes 104₁ to 104_{N} applies a filter to the duplicated data packets so as to extract the IP information and some higher configured protocols, such as File Transfer Protocol (FTP), Hyper Text Transfer Protocol (HTTP), and Wireless Application Protocol (WAP). However, information related to the higher protocols is extracted subsequently as will be described hereinbelow. Finally, each process 104ₙ for 1≦n≦N selects a list from the plurality of lists 108₁ to 108_{N} of the packet list 106, of the shared memory 100, as illustrated in FIG. 2, for storing the extracted layer 3 information of the duplicated data packets.

As mentioned hereinabove, the plurality of processes 104₁ to 104_{N} of the packet capture module 102 are generally run in parallel. Each such process, for example 104₁, receives a different duplicated data packet to handle.

In operation 66, the layer 3 information, extracted from the duplicated data packets during operation 64, is written in the selected lists from the plurality of lists 108₁ to 108_{N}.

Furthermore, the layer 3 information written in the selected lists 108₁ to 108_{N} constitutes the output of the packet capture module 102, which is provided as input to operation 68.

Then, in operation 68, the duplicated data packets from the selected lists 108₁ to 108_{N}, are provided as inputs to the IP processing module 110. The IP processing module 110 uses the plurality of processes 112₁ to 112_{N} to read the duplicated data packets from the selected lists 108₁ to 108_{N}.

After reading the data packets, each process 112ₙ for 1≦n≦N extracts layer 4 protocol information and payload of the duplicated data packets, stored in the selected lists 108₁ to 108_{N}, by using a filter for example.

However, if a duplicated data packet has first undergone IP fragmentation, then each process 112ₙ for 1≦n≦N of the IP processing module 110 select lists from the plurality of lists 116₁ to 116_{N} of the IP fragment list 114 to store the necessary information to do reconstruction of the fragmented data packet.

In operation 70, using the respective selected lists 116₁ to 116_{N}, reconstruction of the fragmented data packet is performed.

Once the fragmented data packet has been reconstructed, it is returned to operation 68 where the plurality of processes 112₁ to 112_{N} extracts the layer 4 protocol information and payload of the reconstructed data packet.

Then, the IP processing module 110 selects lists from the plurality of lists 124₁ to 124_{N} of the TCP list 122 or lists from the plurality of lists 132₁ to 132_{N} of the UDP list 130, depending on the protocol used for transmitting the data packets over the mobile IP network 10 of FIG. 1. The selected lists 124₁ to 124_{N} or 132₁ to 132_{N} are used to store the extracted layer 4 protocol information and payload of the duplicated data packets.

More specifically, in the case where TCP is the protocol used for transmission, lists from the plurality of lists 124₁ to 124_{N} of the TCP list 122 are selected.

Then, in operation 72, the extracted layer 4 information, obtained in operation 68, is written in the selected lists 124₁ to 124_{N}. The extracted layer 4 information of the duplicated data packets, contained in the lists 124₁ to 124_{N}, is then provided as input to operation 74.

In operation 74, the duplicated data packets from the selected lists 124₁ to 124_{N} are provided as input to the TCP processing module 118. The TCP processing module 118 uses the plurality of processes 120₁ to 120_{N} to read the duplicated data packets. More specifically, each process 120ₙ for 1≦n≦N selects a list in the plurality of lists 124₁ to 124_{N} of the TCP list 122 to read and then re-assembles the duplicated data packets to form an ordered TCP stream. Once the duplicated data packets are ordered and re-assembled into an ordered TCP stream, the TCP processing module 118 selects lists from the plurality of lists 144₁ to 144_{N} of the application layer list 142, for writing the ordered data packets thereinto. Each process 120ₙ for 1≦n≦N selects a list from the lists 144₁ to 144_{N}.

It should be noted that the TCP processing module 118 is used to produce an ordered TCP stream from the duplicated data packets, provided as input by the TCP list 122. However, if sometimes, some of the data packets arrive out of order, the TCP processing module 118 then uses the TCP stream list 134 to store, in operation 76, the out of order data packets until they are needed in the re-assembly process of the ordered stream.

Once the lists are selected from the plurality of lists 144₁ to 144_{N} of the application layer list 142, in operation 78, the ordered TCP stream of duplicated data packets is written into the selected lists 144₁ to 144_{N}. The ordered TCP stream of duplicated data packets is then provided as input to operation 80.

Then, in operation 80, the duplicated data packets from the selected lists 144₁ to 144_{N} are provided as input to the application layer analyzer 138. The application layer analyzer 138 uses the plurality of processes 140₁ to 140_{N} to extract the desired information from the layer 4 payload and upper layers of the data packets, by using a filter for example. The extracted information can be subsequently stored in the database 200 and/or sent to the analytic server 32 (see FIG. 1) for an in-depth analysis, when requested by the network operators. Furthermore, the application layer analyzer 138 can include a plurality of analyzers such as WAP 2.0, WAP 1.x, HTTP FTP, E-mail protocols, such as Simple Mail Transfer Protocol (SMTP) and Post Office Protocol (POP3), MMS, Session Initiation Protocol (SIP) for Push-to-talk applications, streaming protocols such as Real-Time Streaming Protocol (RTSP), Real-Time Protocol (RTP), Real-Time Control Protocol (RTCP), Remote Digital Terminal (RDT), Instant Messaging (IM) and presence protocols, for example. The database 200 illustrated in FIG. 4 shows a simplified example of database tables, describing a subscriber, a device, a radius-history, and wap2 transactions, etc.

More specifically, each process from the plurality of processes 140₁ to 140_{N} selects a list, from the plurality of lists 144₁ to 144_{N} of the application layer list 142, to read. Once the selected lists 144₁ to 144_{N} are read and the desired information has been extracted from the data packets contained in the lists 144₁ to 144_{N}, the application layer analyzer 138 then selects a plurality of lists 148₁ to 148_{N} of the processing list 146.

Once the lists 148₁ to 148_{N} have been selected from the processing list 142, in operation 82, the extracted desired information, obtained in operation 80, is written in the selected lists 148₁ to 148_{N}. The extracted desired information is then provided as input to the interaction module 150.

Then, in operation 84, the interaction module 150 uses the plurality of processes 152₁ to 152_{N} to control the number of connections between the filtering and orchestrating server 30 and the cluster 154, and to generate command statements, such as SQL insert statements. The command statements are then provided as input to operation 86.

In operation 86, the command statements are provided as input to the cluster module 154. The cluster module 154 processes the command statements, so that information contained in the processing list 142 is transferred to the staging database. The information is stored in the staging database until the analytic server 32, for example, decides to move the information to a further database, which can be a long-term database. The information is then manipulated and used by the network operators for gaining a better understanding and a continuous real-time view of the traffic flowing in the mobile IP network 10.

Now going back to the IP processing module 110 in operations 68, if instead of TCP, the UDP protocol was used for transmission, then lists from the plurality of lists 132₁ to 132_{N} of the UDP list 130 are selected. Then in operation 88, the extracted layer 4 information, obtained in operation 68, is written in the selected lists 132₁ to 132_{N} of the UDP list 130.

The extracted layer 4 information of the duplicated data packets, obtained in operation 68 and stored in the internal data structures of the selected lists 132₁ to 132_{N} of the UDP list 130, is provided as input to operation 90.

In operation 90, the duplicated data packets are provided as input to the UDP processing module 126. The UDP processing module 126 uses the plurality of processes 128₁ to 128_{N} to read the duplicated data packets provided by the selected lists 132₁ to 132_{N}. Each process 128ₙ for 1≦n≦N selects a list, from the plurality of lists 132₁ to 132_{N}, to read and then extracts the desired information from the duplicated data packets, using a filter for example. Once the desired information has been extracted, the UDP processing module 126 selects lists in the plurality of lists 144₁ to 144_{N} of the application layer list 142, by using, for example, a hashing algorithm. Then, the extracted desired information is written into the selected lists 144₁ to 144_{N}. Finally, the extracted desired information from the selected lists 144₁ to 144_{N} is provided as input to the application layer analyzer 138.

Following operation 90, the same operations as described hereinabove (operation 78 and subsequent operations 80 to 86) are performed.

It should be understood that the method 60 is flexible so as to be able to process additional protocols. Also, the method 60 is flexible so as to read each data packet according to its specific encapsulation and/or layered-structure. Indeed, the order of encapsulation and protocols to read may be different for each data packet. Therefore, the method 60 may process each data packet in a different order of operations as the order of operations described hereinabove.

It is believed to be within the knowledge of one of ordinary skill in the art of network computer programming to program a system to follow the operations described hereinabove and including the modules and the lists described hereinabove.

FIG. 5 shows some non-limitative examples of information extracted by a filtering and orchestrating server 30. The extracted information may include the type of devices used by the subscribers, such as functional parameters, the type and size of objects accessed by the subscribers, geographical location information about the devices, and other layer dependent information, etc.

Although the non-restrictive illustrative embodiment of the present invention was described using a same number of processes and lists (N), it is not necessarily the case, meaning that the number of lists can be different than the number of processes. Indeed, the number of lists is configurable and can vary. The number of processes for each module may be different and can also be varied.

Although the present invention has been described in the foregoing specification by means of a non-restrictive illustrative embodiment, this illustrative embodiment can be modified at will within the scope, spirit and nature of the subject invention.

1. A method for monitoring data traffic flowing through a mobile IP network, in view of providing a substantially real-time view of the mobile IP network, the method comprising:
duplicating the data traffic to produce a copy of the data traffic;
extracting, through a plurality of extraction processes and in relation to a layered-structure of the data traffic, information contained in the copy of the data traffic; and
processing the extracted information through an analytic server to determine trends and behaviors of the data traffic through the mobile IP network during different periods of time and in different geographical regions and thereby provide the substantially real-time view of the mobile IP network.

2. A method for monitoring data traffic as defined in claim 1, wherein duplicating the data traffic comprises providing a point of capture in the mobile IP network for capturing and duplicating the data traffic flowing through the mobile IP network.

3. A method for monitoring data traffic as defined in claim 2, wherein providing the point of capture comprises receiving data traffic from a mobile network.

4. A method for monitoring data traffic as defined in claim 2, wherein providing the point of capture comprises receiving data traffic from an IP network.

5. A method for monitoring data traffic as defined in claim 2, wherein providing the point of capture includes providing a point of capture located outside of a main path of data packet delivery over the mobile IP network.

6. A method for monitoring data traffic as defined in claim 1, wherein extracting, through the plurality of extraction processes and in relation to the layered-structure of the data traffic, the information contained in the copy of the data traffic comprises reading and extracting the information according to at least one layer and a corresponding protocol of the data traffic.

7. A method for monitoring data traffic as defined in claim 6, further comprising extracting the at least one layer and the corresponding protocol of the data traffic.

8. A method for monitoring data traffic as defined in claim 7, wherein extracting the at least one layer and the corresponding protocol of the data traffic comprises extracting a network layer information.

9. A method for monitoring data traffic as defined in claim 7, wherein extracting the at least one layer and the corresponding protocol of the data traffic comprises extracting a transport layer information.

10. A method for monitoring data traffic as defined in claim 7, wherein extracting the at least one layer and the corresponding protocol of the data traffic comprises extracting an application layer information.

11. A method for monitoring data traffic as defined in claim 9, wherein the transport layer information comprises UDP.

12. A method for monitoring data traffic as defined in claim 9, wherein the transport layer information comprises TCP.

13. A method for monitoring data traffic as defined in claim 1, wherein extracting the information contained in the copy of the data traffic further comprises extracting information selected from the group consisting of: communication session information of at least one mobile device; functional parameter information of the at least one mobile device; geographical location information about the at least one mobile device; transaction history information of the at least one mobile device during the communication session; session data records; and layered-structured information of data packet.

14. A method for monitoring data traffic as defined in claim 1, further comprising storing the extracted information in a database.

15. (canceled)

16. A method for monitoring data traffic as defined in claim 1, wherein processing the extracted information through an analytic server comprise performing at least one task selected from the group consisting of: analysis of the extracted information; business intelligence; data mining; trend discovery; behaviour discovery; reporting; and other BSS and DSS purposes.

17. A system for monitoring data traffic flowing through a mobile IP network, in view of providing a substantially real-time view of the mobile IP network, the system comprising:
means for duplicating the data traffic to produce a copy of the data traffic;
means for extracting, through a plurality of extraction processes and in relation to a layered-structure of the data traffic, information contained in the copy of the data traffic; and
means for processing the extracted information through an analytic server to determine trends and behaviors of the data traffic through the mobile IP network during different periods of time and in different geographical regions and thereby provide the substantially real-time view of the mobile IP network.

18. A system for monitoring data traffic flowing through a mobile IP network, in view of providing a substantially real-time view of the mobile IP network, the system comprising:
a duplicator of the data traffic to produce a copy of the data traffic;
an extractor of information contained in the copy of the data traffic, the information being extracted through a plurality of extraction processes and in relation to a layered-structure of the data traffic; and
an analytic server so configured as to process the extracted information to determine trends and behaviors of the data traffic through the mobile IP network during different periods of time and in different geographical regions and thereby provide the substantially real-time view of the mobile IP network.

19. A system for monitoring data traffic as defined in claim 18, wherein the mobile IP network comprises a mobile network and an IP network.

20. A system for monitoring data traffic as defined in claim 19, wherein the mobile network comprises a UMTS network.

21. A system for monitoring data traffic as defined in claim 19, wherein the mobile network comprises a CDMA network.

22. A system for monitoring data traffic as defined in claim 18, wherein the duplicator comprises a switch so configured as to duplicate the data traffic flowing through the mobile IP network so as to produce the copy of the data traffic.

23. A system for monitoring data traffic as defined in claim 18, wherein the duplicator comprises an out-of-band switch so configured as to duplicate the data traffic flowing through the mobile IP network so as to produce the copy of the data traffic.

24. A system for monitoring data traffic as defined in claim 18, wherein the duplicator comprises an optical beam splitter so configured as to duplicate the data traffic flowing through the mobile IP network so as to produce the copy of the data traffic.

25. A system for monitoring data traffic as defined in claim 18, wherein the duplicator comprises a packet capture module so configured as to capture the copy of the data traffic so as to avoid introducing delay in the mobile IP network.

26. A system for monitoring data traffic as defined in claim 18, wherein the extractor comprises a plurality of extracting modules so configured as to extract the data information in relation to the layered-structure of the data traffic.

27. A system for monitoring data traffic as defined in claim 26, wherein the plurality of extracting modules each comprises a filter so configured as to extract specific information contained in the copy of the data traffic.

28. A system for monitoring data traffic as defined in claim 18, wherein the layered-structure of the data traffic comprises at least one layer and a corresponding protocol.

29. A system for monitoring data traffic as defined in claim 26, wherein the plurality of extracting modules comprises a network layer extractor.

30. A system for monitoring data traffic as defined in claim 29, wherein the network layer extractor is so configured as to capture duplicated data packets from the data traffic flowing through the mobile IP network; the network layer extractor is also so configured as to read through the data packets so as to extract layer 3 information by filtering.

31. A system for monitoring data traffic as defined in claim 26, wherein the plurality of extracting modules comprises a transport layer information extractor.

32. A system for monitoring data traffic as defined in claim 31, wherein the extracted transport layer information includes source port, destination port and network response time.

33. A system for monitoring data traffic as defined in claim 26, wherein the plurality of extracting modules comprises a TCP processing module so configured as to order the extracted information and to identify a proper upper layer to which the extracted information will be directed.

34. A system for monitoring data traffic as defined in claim 26, wherein the plurality of extracting modules comprises a UDP processing module so configured as to filter the extracted information and to identify a proper upper layer to which the extracted information will be directed.

35. A system for monitoring data traffic as defined in claim 26, wherein the plurality of extracting modules comprises an application layer extractor.

36. A system for monitoring data traffic as defined in claim 26, wherein the plurality of extracting modules further comprises an extractor of additional information.

37. A system for monitoring data traffic as defined in claim 36, wherein the additional information is selected from the group consisting of: communication session information of at least one mobile device; functional parameter information of the at least one mobile device; geographical location information about the at least one mobile device; transaction history information of the at least one mobile device during the communication session; session data records; and layered-structured information of data packet.

38. A system for monitoring data traffic as defined in claim 18, further comprising a storage element so configured as to store the extracted information contained in the copy of the data traffic.

39. A system for monitoring data traffic as defined in claim 38, wherein the storage element comprises a database.

40. (canceled)

41. A system for monitoring data traffic as defined in claim 18, wherein the analytic server performs at least one task selected from the group consisting of: analysis of the extracted information; business intelligence; data mining; trend discovery; behaviour discovery; reporting; and other BSS and DSS purposes.

42. A system for monitoring data traffic as defined in claim 18, wherein the duplicator and the extractor are located outside a critical path of the data traffic flow in the mobile IP network.
